(19) United States
(12) Patent Application Publication
(10) Pub. No.: US 2010/0177072 A1
(43) Pub. Date: Jul. 15, 2010

(54) ACTIVE MATRIX DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/602,720

(22) PCT Filed: Jun. 2, 2008
(86) PCT No.: PCT/US2008/006956

§ 371 Date: Dec. 2, 2009

(30) Foreign Application Priority Data
Jun. 14, 2007 (JP) 2007-157462
Jun. 14, 2007 (JP) 2007-157463

(51) Int. Cl. G06F 3/038; G09G 3/20

(52) U.S. Cl. 345/205; 345/55; 345/76

(57) ABSTRACT

An active matrix display device, including a pixel array with unit pixel provided with at least one memory pixel, having a 1-bit memory, arranged in a matrix formation, including at least one of a gate selection decoder for selecting gate lines of the pixel array, and a data selection decoder for selecting a data line.

### FIELD OF THE INVENTION

The present invention relates to an active matrix display device, having unit pixels arranged in a matrix shape, for controlling display of these pixels.

### BACKGROUND OF THE INVENTION

A display device receiving digital input, regardless of the type, requires generation of emission intensity, which is analog output, in response to digital data, and digital to analog conversion (DA conversion) means is provided.

WO 2005/116971 and U.S. Pat. No. 6,518,941 disclose an active matrix organic EL panel that is digitally driven. In WO 2005/116971, DA conversion is performed by varying the pulse width of a light emitting period, while in U.S. Pat. No. 6,518,941 DA conversion is realized by using divided pixels having respectively different emission intensities.

Here, retention capacitors are provided in the pixels disclosed in WO 2005/116971 and U.S. Pat. No. 6,518,941, but written data can only be retained for a fixed time. Therefore, in order to constantly maintain emission intensity for that data, an external read and writable memory is provided, and it is necessary to the pixels to be constantly refreshed (operation to write the pixel data at a constant period) using the data in this memory. In particular, when DA conversion is carried out in an emission period, in order to control flicker it is desirable to carry out refresh at a frequency of 60 Hz or higher.

On the other hand, if static memory is adopted inside the pixel, once written data is retained. It therefore becomes possible not only to omit as many parts of the refresh operation as possible, but also to reduce costs without the need for an external frame memory that was provided for refresh.

In the case where DA conversion is carried out in an emission period using a sub-frame, as in WO 2005/116971, fewer memory bits are required for a single pixel, which shows that it is possible to reduce the size and increase resolution. Also, because of the size reduction, wiring capacitance is also small, so even if emission period is varied at a high frequency the effect on power consumption is slight, making it suitable for miniaturized mobile applications such as mobile telephones.

Also, in the case where DA conversion is carried out using hardware with divided pixels of a plurality of bits, as in U.S. Pat. No. 6,518,941, it is necessary to adopt a multiple bit memory in a single pixel. This makes high resolution difficult, but accompanying expansion in pixel pitch by increasing the size, adopting a multiple bit memory is simple. Further, because of the increase in size, wiring capacitance is increased, and power consumption increased, but as long as it is possible to reduce frequency of access to a pixel it is possible to realize a low-cost, large-scale television or monitor with lower power consumption.

Further, in the case where a static memory is adopted in the pixels, read/write access becomes possible, and so it is possible to provide functions such as reading and re-writing data of a required region, and the width of control is expanded. With small-scale or large-scale, even when displaying moving pictures on a display like TV, there is a display method for updating only target domains of user action, such as a display screen of a personal computer. Taking into consideration display characteristics, if the function is used effectively it is possible to improve the performance as a display, such as a reduced power consumption and increased tonal range.

### SUMMARY OF THE INVENTION

Here, a static memory is adopted in the pixel, and in the case implementing functions to read out or write in data of a required region it is desirable to adopt a gate selection decoder that can directly access random lines, from the point of view of controllability. However, since the related art decider is formed using CMOS, manufacturing cost is high, and it is difficult to reduce costs and enlarge the device.

The present invention includes a pixel array with unit pixels, that are provided with at least one memory pixel having a 1-bit memory, arranged in a matrix shape, and includes at least one of either a gate selection decoder for selecting a gate line of the pixel array, and a data selection decoder for selecting a data line.

It is also possible for the memory to be a static memory.

Also, the decoder includes a selection circuit with transistors of the same type connected in series, with one end connected to a selection power supply and the other end connected to the gate line, and a non-selection circuit with transistors of the same type as the selection circuit connected is parallel, with one end connected to a non-selection power supply and the other end connected to a gate line, with the selection circuit and the non-selection circuit being input with address data and a single group of signals selected from address data and the complement of the address data, and the single group of input signals input to the selection circuit and the non-selection circuit preferably having a complementary relationship.

It is also preferably for the selection circuit to have a selection voltage control structure for outputting different selection voltages for reading and writing.

It is also preferable for the decoder to be formed on the same substrate as the memory pixels, and for an organic EL element to be contained in the memory pixel.

In this way, according to the present invention, a decoder is used in selecting a gate line or a data line. Accordingly, it is possible to randomly access the gate line or the data line. It is also possible to form the decoder using the same type of transistors, by providing a selection circuit and no-selection circuit.

### BRIEF DESCRIPTION OF THE DRAWINGS

FIG. 1A is an equivalent circuit diagram of a memory pixel;

FIG. 1B is a layout diagram of a memory pixel;

FIG. 2A is a layout diagram of a 6-bit area gradation generation type pixel array;

FIG. 2B is a layout diagram of a 6-bit area gradation and voltage gradation generation type pixel array;

FIG. 3 shows the overall structure of an organic EL display;

FIG. 4 is a structural diagram of a P-type gate selection decoder;

FIG. 5 is a timing chart for bit data write;

FIG. 6 is a layout diagram of a 3-bit area gradation generation type pixel array;

FIG. 7 is a timing chart for digital drive using sub-frames; and

FIG. 8 is a structural diagram of a P-type data selection decoder.

### DESCRIPTION OF THE PREFERRED EMBODIMENTS

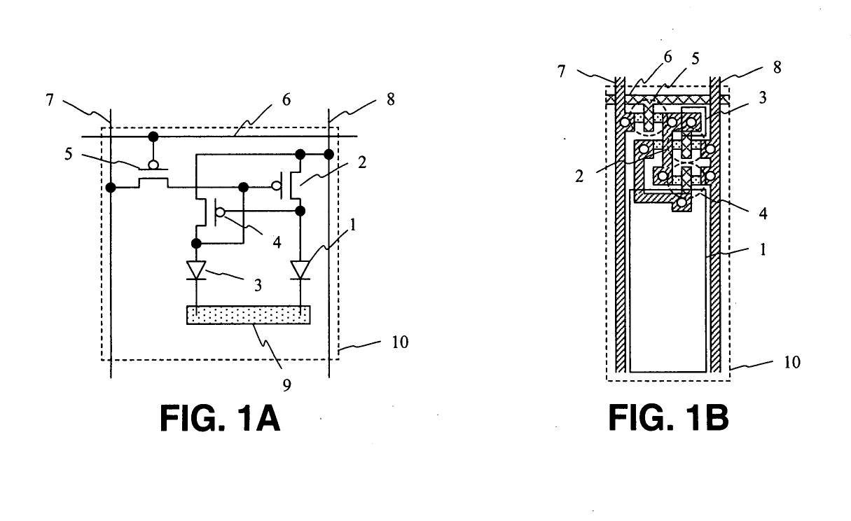

FIG. 1A is an equivalent circuit diagram of a memory pixel including a static memory using only P-type transistors, while FIG. 1B is a layout diagram looking from a surface on which transistors are formed.

One memory pixel includes a first organic EL element 1 that contributes to emission, a first drive transistor 2 for driving the first organic EL element 1, a second organic EL element 3 that does not contribute to emission, a second drive transistor 4 that for driving the second organic EL element 3, and a gate transistor 5 that is turned ON or OFF in response to a selection signal supplied to a gate line 6 and supplies a data voltage that has been supplied to a data line 7 to a gate terminal of the first drive transistor 2 as a result of being ON.

An anode of the first organic EL element 1 is connected to a drain terminal of the first drive transistor 2 and a gate terminal of the second drive transistor 4, while the gate terminal of the first drive transistor 2 is connected to the anode of the second organic EL element 3, the drain terminal of the second drive transistor 4 and the source terminal of the gate transistor 5, with the gate terminal of the gate transistor 5 being connected to a gate line 6 and the drain terminal being connected to the data line 7. Also, source terminals of the first drive transistor 2 and the second drive transistor 4 are connected to a power supply line 8, while the cathodes of the first organic EL element 1 and the second organic EL element 3 are connected to a cathode electrode 9, to thus constitute a memory pixel 10.

The second organic EL element 3 is constructed so that there is no external light emission by shielding with wiring metal and a black matrix etc., or by being formed as an organic EL element that is not luminous. However, a light emission state of the first organic EL element 1 determines the illuminated state of a memory pixel 10.

In the case where data is written into a memory pixel 10, if a write selection signal (a lower “low” level) is supplied to the gate line 6 and the gate transistor 5 is turned on with a lower on resistance, the state of the first drive transistor 2 is determined by the data signal supplied to the data line 7, and the emission/non-emission of the first organic EL element 1 is controlled.

If the gate potential of the first drive transistor 2 is high, that is, the first drive transistor 2 is off, and the second drive transistor 4 is on, and Low data is supplied to the data line 7, then due to the fact that the gate transistor 5 has a lower on resistance than the second drive transistor 4, gate potential of the first drive transistor 2 is reflected at the Low side, which is the potential of the date line 7, even if the second drive transistor 4 is on, turning the first drive transistor 2 on, and current flows in the first organic EL element 1 to emit light. At the same time, the second drive transistor 4 is turned off by the first drive transistor 2 being turning on, and as a result the gate potential of the first drive transistor 2 is lowered to close to the cathode potential at which current ceases to flow in the second organic EL element 3. This potential is continuously applied to the gate potential of the first drive transistor 2 even if the gate transistor 5 is off, which shows that the illuminated state of the first organic EL element 1 is maintained even if a refresh operation is periodically performed.

If the gate potential of the first drive transistor 2 is low, that is, the first drive transistor 2 is on and the second drive transistor 4 is off, and High data is supplied to the data line 7, then due to the fact that the gate transistor 5 has a lower on resistance, current is rapidly supplied to the second organic EL element 3, and if the gate potential of the first drive transistor 2 is made High the first drive transistor 2 is turned off and the first organic EL element 1 stops emitting light. The anode potential of the first organic EL element 1 is lowered to close to the cathode potential, and since it is supplied to the gate terminal of the second drive transistor 4 the second drive transistor 4 is turned on, and while current flows in the second organic EL element 3 the gate potential of the first drive transistor 2 is held High. Specifically, even after the gate transistor 5 turns off, the non-illuminated state of the first organic EL element 1 is continuously maintained. The second organic EL element 3 does not contribute to light emission, and plays a role in maintaining the gate potential of the first drive transistor 2, but because current flowing on the second organic EL element 3 consumes power, it is desirable for the light emitting surface area of the second organic EL element 3 to be formed sufficiently small compared to that of the first organic EL element 1, as shown in FIG. 1B.

In the case of read out, the data line 7 is pre-charged to Low level, and a read signal (a higher Low level) is supplied to the gate line 6. If the gate potential of the first drive transistor 2 is High, that is, the first drive transistor 2 is off and the second drive transistor 4 is on, then due to the fact that the gate transistor 5 has a higher on resistance than the first drive transistor 4, the gate potential of the first drive transistor 2 is kept Higher due to resistance voltage division, and the data line 7 that has been pre-charged with Low data is charged to High.

In the case where the gate potential of the first drive transistor 2 is Low, since there is no variation for a long period of time on the data line 7 that has been pre-charged to Low, the memory can determine that High data has been written if the data line is High after a specified time has elapsed, or that Low data has been written if the data line is still Low.

In this way, by applying different select voltages to the gate line 6 for writing and for reading, it is possible to perform reading and writing of data using the memory pixel of FIG. 1A and FIG. 1B.

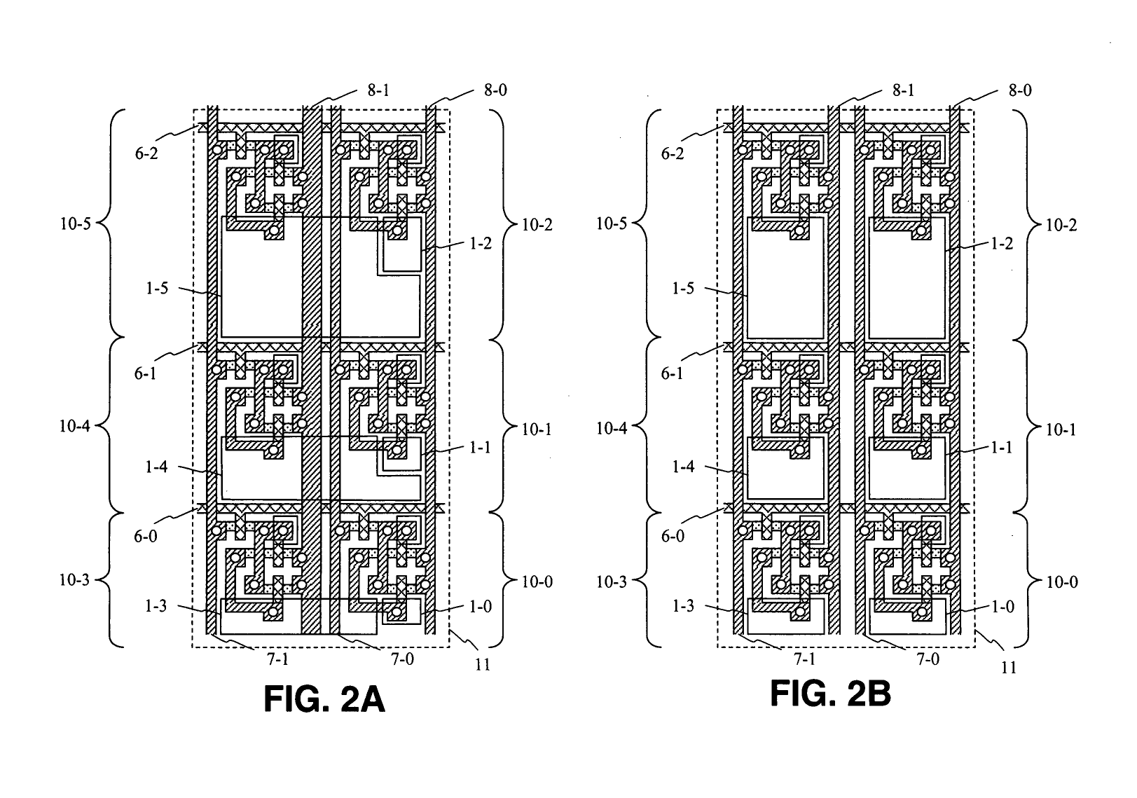

FIG. 2A and FIG. 2B are layout diagrams of a pixel 11 having a 6-bit DA conversion function using six of the memory pixels 10 of FIG. 1A and FIG. 1B. In the case of full color, pixels 11 are provided in a minimum of three colors for one pixel, such as R (red) G (green) and B (blue).

As shown in FIG. 2A and FIG. 2B, a plurality of memory pixels 10 having different light emitting surface areas are provided in one pixel 11, and in the case of implementing area gradation, even if the above described read and write logical operations are the same for each memory pixel 10, emission strength that is output will be different according to emission area of each pixel memory. Therefore, effectively forming light emission areas at desired proportions in each memory pixel is an important point.

In FIG. 2A, an example is shown where emission areas are effectively formed so that emission areas of the first organic EL elements 1-0 to 1-5, being structural elements of each of the memory pixels 10-0 to 10-5 included in the pixel 11 so that a relationship of respective proportions is 1:2:4:8:16:32, and if the same potential is supplied to the power lines 8-0 and 8-1 the light emission intensities of each memory pixel 10-0 to 10-5 have the same ratios.

When adopting area gradation, it is necessary to sufficiently take into consideration the case where the emission region of the first organic EL element 1-0 of the LSB (Least Significant Bit) memory pixel becomes much smaller than the transistor formation region. With this example, the ratio of the MSB (Most Significant Bit) to the LSB is 32:1, and the emission region of the LSB memory pixel is smaller compared to the transistor formation region.

The formation region of the transistor circuit should occupy the same area in all of the memory pixels, and so in distributing the emission areas of the organic EL elements so as to have a desired ratio it is effective to further form three rows and two columns of sub-matrices as shown in FIG. 2A, for example, and redistribute the emission areas in the respective memory pixels. The reason for doing this will be described in the following.

For example, it is necessary to form the organic EL elements 1-5 and 1-2 with an emission area ratio of 32:4 (8:1), but these two memory areas are preferably made adjacent. This is because the organic EL element 1-5 can have a sufficiently expanded emission area using an organic EL formation possible region that is not required by the organic EL element 1-2. The same also applies appropriately to the organic EL elements 1-4 and 1-1, and 1-3 and 1-0. Memory pixels forming pairs in this way are next arranged vertically, and by respectively adjusting the vertical lengths so that the emission areas of the organic EL elements 1-5, 1-4 and 1-3 become 4:2:1 it is possible to effectively form emission areas at desired ratios even with memory pixels having the same transistor region.

With respect to the first organic EL elements 1-5, 1-4 and 1-3 of FIG. 2A, in the case of bottom emission type organic EL elements for extracting emitted light to the opposite side of the transistor formation surface, since part of the emission region is shielded by the power supply lines 8-1 and 8-0, and the data lines 7-0 and 7-1, and emission area is lowered, it is necessary to adjust emission area taking into consideration the wiring regions, but it is not necessary to consider this in the case of top emission type organic EL elements for extracting emitted light to the transistor formation surface side.

Alternatively, as shown in FIG. 2B, emission regions of the first organic EL elements are made the same for 1-3 and 1-0, for 1-4 and 1-1, and 1-5 and 1-2, and it is possible to generate desired emitted light intensities by varying the power supply voltage applied to the emission areas and the organic EL elements, such as by applying different potentials to the power supply lines 8-0 and 8-1. For example, if a potential V1, that is higher than a potential V0 of the power supply line 8-0, is applied to the power supply line 8-1, the first organic EL element 1-5 has an emission intensity larger than that of 1-2, and if power supply potentials V1 and V0 of the power supply lines 8-1 and 8-0 are determined so that the emission intensities are in the ratio 8:1, then it is possible to generate 6-bit gradation without inconsistencies, the same as in FIG. 2A. However, since there are differing current densities at the time of light emission, with the first organic EL elements 1-5, 1-4 and 1-3 that emit light with the application of a higher potential V1, and the first organic EL elements 1-2, 1-1 and 1-0 that emit light with the application of the lower potential V0, then in the case of simultaneous light emission, degradation will occur earlier in the former. Therefore, by alternately switching the potentials V1 and V0 applied to the power supply lines 8-1 and 8-0, it is possible to make deterioration of the organic EL elements uniform. At this time, since emission intensity also varies if the potential is switched, control is performed so that bit data corresponding to memory pixels for generating respective emission intensities is written. Specifically, bit data is written to each memory pixel so that in the case of applying V1 to the power supply line 8-1 and V0 to the power supply line 8-0, fifth bit data is reflected at the memory pixel 10-5 and second bit data is reflected at the memory pixel 10-2, but if V0 is applied to power supply line 8-1 and V1 is applied to power supply line 8-0, second bit data is reflected at the memory pixel 10-5 and fifth bit data is reflected at the memory pixel 10-2.

In the case where bit data is determined for each memory pixel in hardware, as in FIG. 2A, the width of the power supply line 8-1 for supplying current to the first organic EL elements 1-5, 1-4, 1-3 of the upper three bits is fatter than the thickness of the power supply line 8-0 for supplying current to the first organic EL elements 1-2, 1-1, 1-0 of the lower three bits, and it is possible to control lowering of potential due to eight times the amount of current flowing.

In this way, it becomes possible to easily form organic EL elements having different emission areas by further arranging memory pixels in a sub-matrix shape of three rows and two columns inside a single pixel, and leaving a margin for expansion of emission areas vertically and to the left and right.

Also, if elements are arranged in a sub-matrix of three rows by two columns, it is possible to have three gate lines 6 (6-2, 6-1, 6-0) in a single pixel in order to access each memory pixel. If memory pixels are arranged in six rows and one column, it is necessary to have six gate lines 6 in a single pixel, and a gate selection decoder circuit, which will be described later, for selective control of these gate lines, will also be enlarged. From the viewpoint of structure of this type of gate selection decoder also, there is an advantage in the sub-matrix structure. Only an example of the sub-matrix structure formed from 6-bit memory pixels is shown in FIG. 2, but in the case of 4-bits, it is possible to configure a sub-matrix from four memory pixels, for example 10-1, 10-2, 10-4 and 10-5, and it goes without saying that the same methodology can be adopted, for example, in the case of a two bit memory pixel having only two memory pixels 10-5 and 10-2.

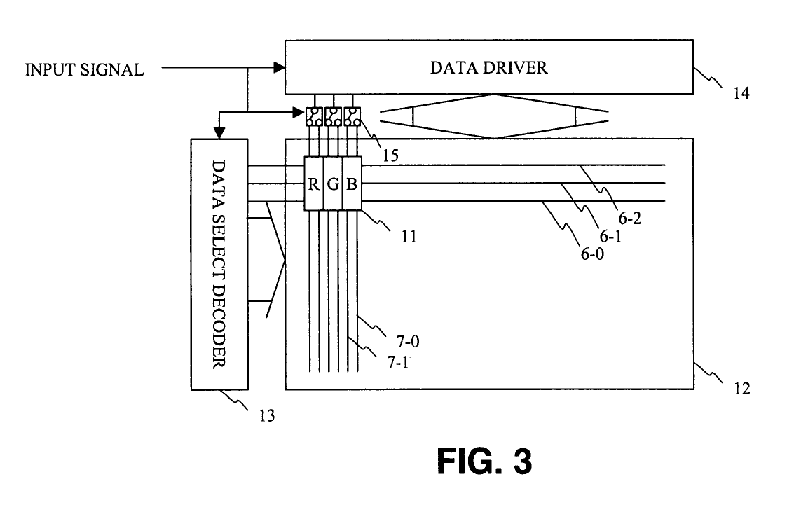

FIG. 3 shows the overall structure of an organic EL element constructed from a pixel array 12 in which the pixels 11 of FIG. 2 are arranged in a matrix shape, a gate selection decoder 13 for controlling selection/non-selection of the gate line 6, a data driver 14 capable of outputting inputting bit data to the pixel array 12 and receiving input from the pixel array 12, and a bit selector 15 for switching bit data supplied to the data line 7.

Frequently, the pixel array 12 and the gate selection decoder 13, and the bit selector 15, are formed on the same substrate, but it is possible to further reduce costs if the data driver 14 is also formed on the same substrate. Alternatively, it is also possible to form the data driver 14 with an IC.

In the case of displaying an image input externally, the data driver 14 converts data transferred in dot units to line data, and outputs to the data lines 7-0 and 7-1 in line units. Data output to the data lines 7-0 and 7-1 are written to the pixel 11 of the line selected in the gate election decoder 13, but this data writing is carried out in bit units. Specifically, at the time of data writing of any of the upper three bits, the bit selector 15 connects output of the data driver 14 to the data line 7-1, and at the time of data write of any of the lower three bits the bit selector 15 connects output of the data driver 14 to the data line 7-0. At the same time, if bit data is for the 5th bit or the 2nd bit, the gate line 6-2 is selected by the decoder 13, if the bit data is the 4th or 1st bit the gate line 6-1 is selected, and if the bit data is the 3rd or 0th bit the gate line 6-0 is selected, a bit data corresponding to each memory pixel is written at a timing that will be described later.

Once written bit data is held inside the pixel memory, and so it is not necessary to write data to the pixel at a constant cycle by always operating the gate selection decoder 13. It is possible to update corresponding pixels pixel 11 only in the event that the image changes. Therefore, it is possible to reduce the cost of the display without the need to adopt a frame memory for refresh externally or inside the data driver 14.

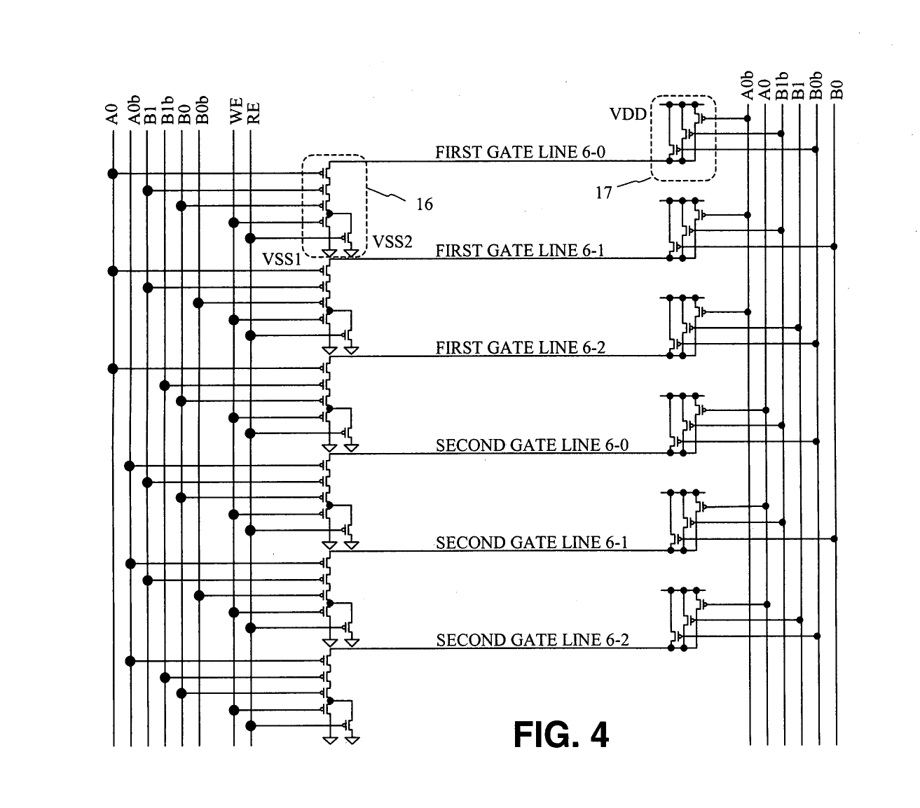

FIG. 4 shows the structure of the gate selection decoder 13, but in order to simplify the description an example of driving a pixel array with the pixel of FIG. 2 formed from 2 lines is shown. The gate selection decoder 13 includes selection circuits 16 and non-selection circuit 17, with corresponding lines from three bit address data {A0.B1,B0} and {A0b, B1b, B0b}, which are complementary data, selected by being driven Low, and non-corresponding lines being non-selected by all being driven High. The selection circuit 16 includes a election decode section with three P-type transistors connected in series, and a selection voltage control section for switching a selection voltage level using a write enable signal WE and a read enable signal RE, and the non-selection circuit 17 includes a non-select decode section with three P-type transistors connected in parallel.

Logic is formed whereby the select decode section is turned on when all three inputs are Low, and the non-select decode section is off when all three inputs are High, and both the select decode section and the non-select decode section are in a complementary relationship with a combination of address data {A0, B1, B0} and its complementary data {A0b, B1b, B0b}. That is, among the six inputs {A0, A0b, B1, B1b, B0, B0b}, if three inputs of the select decode section 16 are connected to {C, D, E}, the three inputs of the non-select decode section are connected to {c, d, e}. However, c=complement of C, d=complement of D, e=complement of E. If connections are made in this way, if the gate lines are selected by the selection circuit 16 then the non-selection circuit 17 is invariably off, and if the selection by the selection circuit 16 is released the non-selection circuit 17 is invariably on. For example, in the case of selecting the first gate line 6-1, the selection decode section of the first gate line 6-1 is selected when its three inputs are address data {0,0,1}, which shows that the object of connection is preferably {A0, B1, B0b}. Together with this, the non-selection circuit 17 isolates the first gate line 6-1 from the non-select voltage VDD with address data {0,0,1}, and so the connection object for those three inputs is {A0b, B1b, B0}. As a result, all Low is input to the three inputs of the decode section of the selection circuit 16 and all high is input to the three inputs of the non-selection circuit 17, and the first gate line 6-1 can be consistently selected with address data {0,0,1}.

The selection voltage control section of the selection circuit 16 selects a Low level (VSS1) that is sufficiently low for writing, by making the write enable signal WE low and the read enable signal RE high at the time of write selection, and selects a Low level (VSS2) appropriate for reading by making the read enable signal RE Low and the write enable signal WE High at the time of read selection. On the other hand, a high level (VDD) sufficient for non-selection of the gate line is supplied to the non-selection circuit 17.

The line address A0 determines which of the two lines will be selected, and the bit address {B1, B0} designates which bit memory pixel is written to. For example, when 0th bit data is written to the 0th bit memory pixel of the first gate line 6-0, {A0, B1, B0} are made {0,0,0}, and by making the write enable signal WE Low and the read enable signal RE High, the selection circuit 16 of the first gate line 6-0 drives the first gate line 6-0 sufficiently low for writing. At the same time, since {A0b, B1b, B0b} becomes {1,1,1}, the non-selection circuit 17 of the first gate line 6-0 becomes off, and the first gate line 6-0 is driven Low as is, and 0th bit data supplied to the data line 7-0 is written to the memory pixel. When writing 1st bit data to the 1st bit memory pixel of the first gate line 6-1, if A0 and B1 are left as they are and B0 is made “1”, then B0b becomes “0”, and at the same time as the first gate line 6-1 is make Low by the selection circuit 16 the non-selection circuit 17 goes off and the first gate line 6-1 is driven Low. On the other hand, by making B0 “1” selection of the selected first gate line 6-0 by the selection circuit 16 is released, and at the same time, by making B0b “0” High is supplied by the non-selection circuit 17 to give non-selection. Selection of lines of other than designated addresses by the selection circuit 16 is also released, and these lines are driven high by the non-selection circuit 17 to effect non-selection.

When bit data is read from the pixel memory, after the data line 7 has been pre-charged to Low, by making the read enable signal RE Low and making the write enable signal WE High the gate line is read selected, and data of the same address can be read onto the data line 7.

In this way, if a decoder formed using a selection circuit 16, having a select decode section with transistors of the same type and the same in number as the number of bits of the address connected in series, and a non-selection circuit 17 having transistors of the same type connected in parallel, is used, it is possible to perform accesses to read and write randomly to all gate lines.

FIG. 4 is an example of an address decoder for a line address of one bit (2 lines), but even if there area lot of lines and there is a need for an address decoder for 8 bits (256 lines), it is possible to make the number of transistor connected in series in the decode section of the selection circuit 16 ten (line address 8+bit address 2), and to similarly form the gate select decoder with the number of transistors connected in parallel in the non-selection circuit 17 ten.

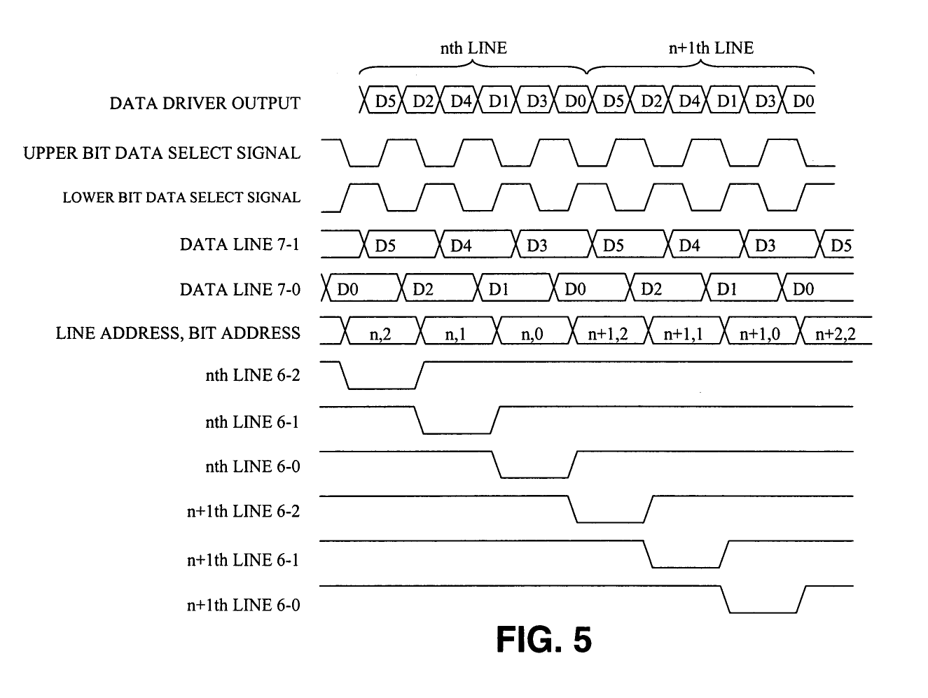

FIG. 5 is a timing chart for gate line selection control using control signals for the bit data supplied from the data driver 14, and the bit selector 15 (upper bit data select signal, lower bit data select signal), and the decoder 13.

Since it is possible for the pixel of FIG. 2 to write 2-bit data supplied to the data lines 7-0 and 7-1 with selection of a single gate line, the data driver 14 outputs data in the bit data order written with a single selection. For example, if 5th bit data D5 is output and Low is input to the bit selector 15 as an upper bit data select signal, the output of the data driver 14 is connected to the data line 7-1, and data D5 is supplied to the data line 7-1. Next, after the upper bit data select signal has been released (High) and the data D5 retained on the data line 7-1, of 2nd bit data D2 is output from the data driver 14 and Low is input as the lower bit data select signal, the output of the data driver 14 is connected to the data line 7-0 and data D2 is supplied to the data line 7-0. While data D5 and D2 are being retained on the data line 7-0 and 7-1, if the nth gate line 6-2 is in a selected state data D5 and D2 are written to the memory pixels of the 5th and 2nd bits that share the same gate line, and data that has been written to the memory pixels by selection of lines other than the nth gate line 6-2 is finalized.

After that, 4th bit data and 1st bit data, and 3rd bit data and 0th bit data, are sequentially output from the data driver 14, but respective bit data is supplied to data lines leading to corresponding memory pixels by similarly controlling the bit selector 15, and the nth line bit data writing by selecting the gate lines using bit address selection is completed. By repeating this, it is possible to write all bit data of all lines to the memory pixels, and writing of all image data is completed.

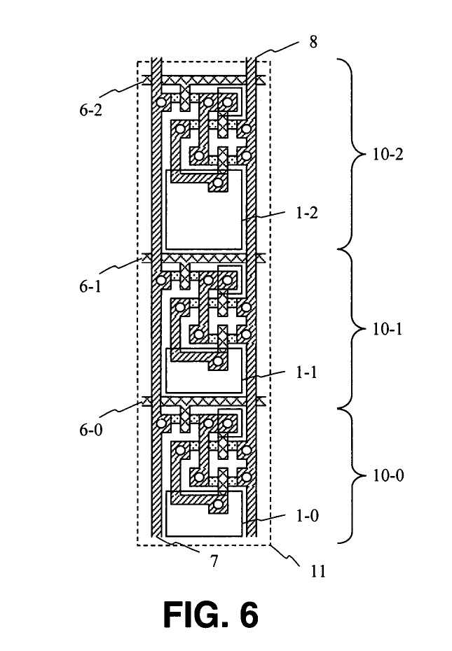

However, in cases where small size and high brilliance are required, such as with a mobile terminal, it is difficult to adopt a 6-bit memory pixels for a single pixel, and so it is preferable to adopt only 3-bits in a single pixel, as shown in FIG. 6, and to omit some of the external memory. However, in the case of generating 6-bit gradation, it is necessary to externally provide 3 or more bits of memory either inside the data driver 14, or externally.

The pixel of FIG. 6 has emission areas of first organic EL elements 1-2, 1-1, 1-0 set at roughly 2:1:1, with memory pixels arranged in three rows and one column, different from FIG. 2. Put more precisely, in order to generate 6-bit gradation, the ratio of the first organic EL elements 1-1 and 1-0 of the memory pixels 10-1 and 10-0 is preferably 16:15, but it is better to make at least the first organic EL element 1-0 equal to the first organic EL element 1-1, or larger. As will be described later, the memory pixel 10-0 has a function of adjusting brightness by varying light emission period using sub-frames. With the pixel structure shown in FIG. 6 also, it is possible to effectively control reading and writing by using the gate select decoder 13.

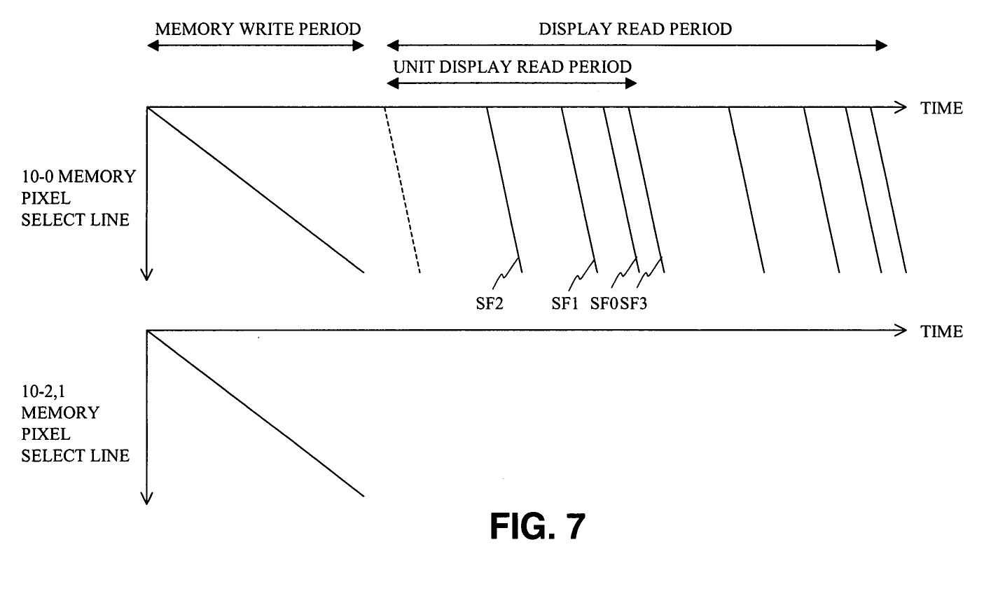

FIG. 7 shows a timing chart of digital drive for generating 6-bit gradation using 3-bit memory pixels contained in the pixel of FIG. 6 and 3-bit external memory. With the example of FIG. 7, of the 3-bit memory pixels, 10-2 and 10-1 are allocated exclusively to the upper two bits, while 10-0 is shared by the remaining four bits.

First, in the memory write period of FIG. 7, upper 3-bit data is written to the 3-bit memory pixels, and the remaining lower three bits are written to memory adopted externally, for example, inside the data driver 14. The order of writing to the memory pixels s the same as in FIG. 5, but one pixel is provided with only 3-bit memory pixels, which means that the bit selector 15 is not required. If the memory write period is ended, the bit data of the upper two bits is continuously held by the exclusively dedicated memory pixels 10-2 and 10-1 for as long as there is no need for update due to image data being input from outside. The remaining lower 4-bits reproduce 4-bit gradation using the memory pixel 10-0 and the sub-frames SF0-SF3.

With the display period using sub-frames, since there is no need to access the memory pixels 10-2 and 10-1, the bit address {B1, B0} shown in FIG. 4 is constantly fixed at {0,0}, and it is possible to limit access to the memory pixel 10-0. In this way, access to the memory pixels 10-2 and 10-1 is avoided.

Immediately after memory write, 3rd bit data D3 is written to the memory pixel 10-0, and at a time when the initial 2nd bit sub-frame SF2 starts the 2nd bit data D2 is read from the external memory, but mistakenly writing that directly to the memory pixel 10-0 will overwrite the 3rd bit data D3, thus losing the 3rd bit data. This is because the place where the 3rd bit data is stored is not outside the memory pixel 10-0. Consequently, 2nd bit data D2 of the nth line that has been read from external memory is temporarily shunted to a line memory or the like, and if the 3rd bit data D3 read from the nth line memory pixel 10-0 is stored at an address where that 2nd bit data D2 is stored, loss of the 3rd bit data D3 is prevented. The logic of this can be understood from the fact that overall capacity of the memory pixels and the external memory is the same 6 bits.

Similarly to when the first bit sub-frame SF1 is started, first bit data D1 is read from the external memory and shunted, and 2nd bit data read from the pixel memory 10-0 is stored at the read out external memory address. Bit data for which it is intended to repeat the same thing in other sub-frames will also not be lost, and it is possible to reproduce 4-bit gradation using the memory pixel 10-0.

If a 4-bit memory is adopted externally, then bit data is read from the memory pixels as described above, and it is not necessary to perform drive while switching between input of the external memory and the bit data. Specifically, in the memory write period 3rd bit data D3 is written to both the memory pixels and the external memory, or to only the external memory, and in each sub-frame period 4-bit data from the 3rd to 0th bit data read from the external memory having 4-bits can be overwritten and written to the memory pixel 10-0 in sub-frame order.

In this case, for the memory pixels since it is possible to have only control for write only, switching of select voltage using the write enable signal WE and the read enable signal RE is no longer required, and it is possible to omit selection voltage control section of the selection circuit 16.

If the memory pixel of FIG. 6 and the decoder 13 are used, there is the advantage that it is possible to limit regions where there is digital drive by the sub-frames to only display regions required for multiple tone display. For example, a case will be considered where an upper half of a display region is used as a natural image display region for photographs etc., and the lower half is used as a text display region for electronic mail etc., such as quite often arises with portable terminals etc. The text region of the lower half of a display region does not require multiple tone display, and so the decoder 13 can be operated so as to update only sections that change, using only 2-bit data of the memory pixels 10-2 and 10-1. Sections that have variation have the possibility of occurring at random, and because the decoder is capable of direct access it is efficient compared to selection means such as sequentially selecting, like a shift register.

The upper half of a display region requires periodic update with bit data corresponding to each sub-frame, using digital drive, but since the entire screen does not require updating there is no need to cause the decoder 13 to operate from the bottom to the top, and it is possible to reduce power consumption in data writing.

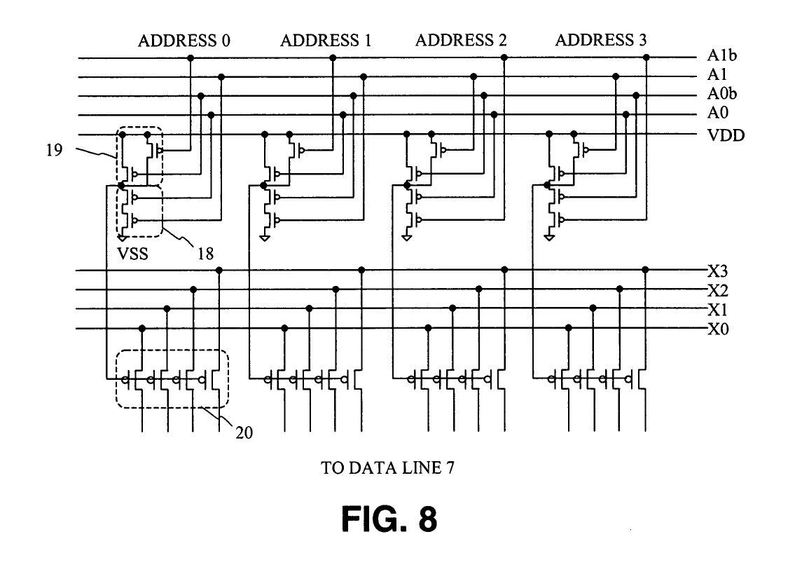

Further, adopting the decode circuit of FIG. 4, it is possible for the data driver 14 to constitute a data select decoder using P-type transistors, as shown in FIG. 8, and to form the memory pixels on the same substrate.

In FIG. 8, an example is shown where a selection circuit 18 and a non-selection circuit 19 that are operated by address data {A1, A0}, and its complement data {A1b, A0b} are provided on the basis of one for every four data lines, with a switch 20 being controlled by one select/non-select circuit, so as to be able to simultaneously access four data lines via the data bus X0 to X3. The principle of operation is the same as for FIG. 4. Since the address is 2-bits in the example of FIG. 8, it is possible to freely access four addresses. For example, when the address data {A1, A0} is {0,0}, the complement address {A1b, A0b} becomes {1,1}, Low (VSS) is applied to the input of the switch 20 of address 0, and the data line group of address 0 is simultaneously connected via the switch 20 to the data bus X0-X3. At this time, if bit data for four rows are supplied to the data bus X0-X3, data is supplied in one go to data lines 7 of four rows. Then, if the address data {A1, A0} is changed to {0,1}, the complement address {A1b, A0b} is also updated to {1,0}, selection of address 0 is released by the selection circuit 18, High (VDD) is supplied to the input of the switch 20 by the non-selection circuit 19, and the data line group of address 0 is disconnected from the data bus X0-X3. If this is done, at the same time the switch 20 for address 1 is turned on by the selection circuit 18 of address 1, the data line group for address 1 is connected to the data bus X0-X3, and the bit data on the data bus is supplied to the respective data lines 7. In the case of reading data from a memory pixel onto the data bus X0-X3, the corresponding gate lines are read selected, and data of the memory pixel is read onto the data line, but only address data lines designated by the address data {A1, A0} are connected to the data bus X0-X3, read onto the data bus and accessed from outside.

By combining a data select decoder such as that of FIG. 8 into the data driver 14, it is possible to easily limit data update regions. For example, updating only data of a column width w of the nth line, can be done as follows. The data lines 7 are precharged, the nth line is selected by the decoder 13, and bit data of the nth line is read from the memory pixel to the data lines 7. Then, if the subject write address is designated and the corresponding bit data is supplied onto the data bus, the switch 20 of the designated address is connected to the data bus, and data on the data lines of the previously read corresponding row is overwritten with data on the data bus. Data lines for rows not designated by the address have the switch 20 off, which shows that date read from the pixel memory is maintained as it is. By releasing the nth line selection by the gate selection decoder 13, data on the data lines is fixed as memory pixel data, and so the memory pixels of the column width w are updated, and the same data that has been read is written again to other memory pixels. If similar control is repeated for only one line, it is possible to update only a region of width w and length l.

As required, it is possible to form only the data select decoder of FIG. 8 on the same substrate as the pixel array, and instead of the gate elect decoder 13 have a structure using a gate driver formed of shift registers or the like, or using a gate driver IC for providing these functions in an IC.

In any case, if it is possible to configure a data select decoder with transistors of the same type, like in FIG. 8, as part of the data driver 14, it is possible to realize a multiple function organic EL display at low cost.

Also, because it is possible to form the gate selection decoder and data selection decoder, and the memory pixels, with transistors of a single type, they can be formed using not only low temperature polysilicon an amorphous silicon, but also organic semiconductor or oxide semiconductor. Besides a glass substrate, it is also possible to form a flexible display by forming the components on a plastic substrate etc.

The decoder of FIG. 4 and FIG. 8 can also be applied to a system adopting pixels that do not utilize static memory, and it goes without saying that they can also be effectively used with display elements such as liquid crystal.

### PARTS LIST

1 organic EL element

2 drive transistor

3 organic EL element

4 drive transistor

5 gate transistor

6 gate line

7 data line

8 power supply line

9 cathode electrode

10 memory pixel

11 pixels

12 pixel array

13 gate election decoder

14 data driver

15 bit selector

16 selection circuits

17 non-selection circuit

18 selection circuit

19 non selection circuit

20 switch

1. An active matrix display device, including a pixel array with unit pixel provided with at least one memory pixel, having a 1-bit memory, arranged in a matrix formation, comprising:
at least one of a gate selection decoder for selecting gate lines of the pixel array, and a data selection decoder for selecting a data line.

2. The active matrix display device of claim 1, wherein the memory is static memory.

3. The active matrix display device of claim 1, wherein:
the decoder comprises a selection circuit, with transistors of the same type connected in series, one end being connected to a selection power supply and the other end being connected to a gate line;
a non-selection circuit, with transistors of the same type as the selection circuit connected in parallel, one end being connected to a non-selection power supply and the other end being connected to a gate line; and
the selection circuit and the non-selection circuit receive input of one group of signals selected from address data and a complement of the address data, and the single group if signals input to the selection circuit and the non-selection circuit have a complementary relationship.

4. The active matrix display device of claim 1, wherein the selection circuit has selection voltage control means for outputting different selection voltages for reading and writing.

5. The active matrix display device of claim 1, wherein the decoder is formed on the same substrate as the memory pixels.

6. The active matrix display device of claim 1, wherein the memory pixels include an organic EL element.

7. An active matrix display device, having unit pixels arranged in a matrix shape, for controlling display of these pixels, wherein:
the unit pixels are provided with a plurality of memory pixels having a single bit memory, and the plurality of memory pixels are arranged in two or more rows, with a power supply being wired corresponding to each row of memory pixels.

8. The active matrix display device of claim 7, wherein the memory of the memory pixels is static memory.

9. The active matrix display device of claim 7, wherein power supply lines that are connected to pixels arranged adjacently in a row direction or column direction arranged inside the unit pixels have different wiring widths from each other.

10. The active matrix display device of claim 7, wherein voltages supplied to power supply lines that are connected to pixels arranged adjacently in a row direction or column direction arranged inside the unit pixels are different from each other.

11. The active matrix display device of claim 7, wherein an area where light is emitted to outside in a pixel arranged inside the unit pixel is different from at least some of the adjacent pixels in the row direction and column direction.
